(19) United States
(12) Patent Application Publication
(10) Pub. No.: US 2015/0368928 A1
(43) Pub. Date: Dec. 24, 2015

(54) SECURITY LOCK WITH DEFORMABLE LATCH

(71) Applicant: McGard LLC, Orchard Park, NY (US)

(72) Inventors: Weston J. Ulrich, West Falls, NY (US); David C. Meyer, Boston, NY (US); Steven M. McHugh, Hamburg, NY (US); Scott E. Hunter, Eden, NY (US)

(21) Appl. No.: 14/741,195

(22) Filed: Jun. 16, 2015

Related U.S. Application Data
(60) Provisional application No. 62/015,704, filed on Jun. 23, 2014.

(51) Int. Cl. E05B 15/00

(52) U.S. Cl. CPC E05B 15/00

(57) ABSTRACT

A security lock includes a first lock component lockingly engagable within a second lock component. Locking engagement is provided by way of a deformable latch member on the first lock component engaging a latch retainer on the second lock component. The second lock component has a key-receiving configuration that accepts a key. The key is configured to deform the latch member in order to release the first lock component from the second lock component.

### TECHNICAL FIELD

The present disclosure relates to lock mechanisms. More particularly, the disclosure is directed to key-actuated security locks that can be unlocked without key rotation, and do not require a key for installation/locking.

### BACKGROUND ART

By way of background, various types of security locks that require key-actuation have been proposed, for a variety of purposes. Examples include padlocks, door locks and tube locks to name but a few. A common feature of such locks is that they require the key to be rotated in order to cause unlocking. Moreover, most, if not all, security lock mechanisms require “N” moving parts (where N is ≧2), and thus have N degrees of design complexity.

It is to improvements in security lock mechanisms that the present disclosure is directed. In particular, a key-actuated security lock is proposed that can be unlocked without key rotation, and does not require any key at all for installation/locking. The disclosed security lock is applicable to virtually any type of locking application. Although not a requirement, embodiments of the security lock may be implemented with as little as one moving part within the lock. The construction of a security lock with only a single moving part allows the lock to perform well in harsh weather conditions because the lock is not dependent on multiple pieces functioning together in mutual cooperation during locking or unlocking operations.

### BRIEF SUMMARY OF THE INVENTION

In one aspect, a security lock includes a first lock component insertable within a second lock component and lockingly engagable therewith. Locking engagement is provided by way of a deformable latch member on one of the lock components engaging a latch retainer on the other lock component. The lock component with the latch retainer has a key-receiving configuration that slidably accepts a key and allows it to contact the latch member on the other lock component. The key is configured to deform the latch member out of engagement with the latch retainer in order to release the first lock component from the second lock component and thereby unlock the security lock. The security lock is lockable without the key.

In an example embodiment, the first lock component may comprise a lock pin. In an example embodiment, the second lock component may comprise a lock body having a lock bore configured to receive the lock pin. In an example embodiment, the deformable latch member may comprise a single moving part. In an example embodiment, the deformable latch member may comprise a compressible snap-ring. In an example embodiment, the latch retainer may comprise a retainer groove configured to receive and lockingly engage the snap-ring. In an example embodiment, a cam surface may be provided to deform the latch member prior to the latch member engaging the latch retainer. In an example embodiment, the key-receiving configuration may comprise at least one opening to accommodate at least one protrusion on the key that contacts the latch member. In an example embodiment, the at least one opening of the key-receiving configuration may comprise plural openings configured as longitudinal grooves, and the at least one key protrusion may comprise plural protrusions configured as longitudinal teeth that are slidably engagable with the grooves. In an example embodiment, the grooves may have irregular spacing relative to each other and the teeth may have a matching irregular spacing to provide a security function. In an example embodiment, the key-receiving configuration may include a shroud providing a key-way for guiding the key. The key-way may be restricted in size to prevent deformation of the latch member except by the key.

In another aspect, a security lock mechanism includes a lock pin and a lock body. A lock bore in the lock body is configured to receive the lock pin. A compressible snap-ring is provided on the lock pin, and a retainer groove is provided in the lock bore. A sidewall on the lock bore between the retainer groove and an open end of the lock bore is adapted to receive the lock pin. The sidewall includes a cam surface to compress the snap-ring as the lock pin advances into the lock bore. The retainer groove is sized to allow the snap-ring to uncompress and thereby become captured in the retainer groove, in locking engagement therewith, the locking engagement securing the lock pin in the lock bore. The lock body has one or more openings permitting access to the snap-ring by one or more protrusions on a key when the snap-ring is captured in the retainer groove. The key is configured to engage the lock body with the key protrusions compressing the snap-ring out of locking engagement with the retainer groove, thereby releasing the lock pin from the lock bore. A shroud may be mounted on the lock body. The shroud provides a key-way that guides the key during its engagement with the lock body. The key-way is restricted in size to prevent deformation of the snap ring except by the key.

### BRIEF DESCRIPTION OF THE DRAWINGS

FIG. 1 is a perspective view showing an example security lock that may be formed in accordance with the present disclosure, with the lock being shown in a locked position.

FIG. 2 is a perspective view showing the security lock of FIG. 1 with the lock in an unlocked and separated position.

FIG. 3 is an exploded perspective view showing the security lock of FIG. 1 to illustrate example components and subcomponents that may be used therein.

FIG. 4 is a perspective view showing the security lock of FIG. 1 in a locked position prior to engagement with a key.

FIG. 5 is a perspective view showing the security lock corresponding to FIG. 4 following unlocking by the key but prior to separation of the lock components.

FIG. 5A is a perspective view showing the security lock corresponding to FIG. 4 following unlocking by the key and separation of the lock components.

FIG. 6 is an enlarged side elevation view showing the security lock of FIG. 1 in the unlocked and separated position.

FIG. 7 is a cross-sectional view taken along line 7-7 in FIG. 6.

FIG. 8 is a cross-sectional view corresponding to FIG. 7, with the main lock components being partially engaged and moving toward the locked position.

FIG. 9 is a cross-sectional view corresponding to FIG. 7, with the main lock components being fully engaged in the locked position.

FIG. 10 an enlarged side elevation view showing the security lock of FIG. 1 in the locked position.

FIG. 11 an enlarged side elevation view showing the security lock of FIG. 1 in the locked position prior to engagement with a key.

FIG. 12 is a cross-sectional view taken along line 12-12 in FIG. 11.

FIG. 13 is a cross-sectional view corresponding to FIG. 12, with the main lock components being locked and the key engaging the lock and initiating an unlocking sequence.

FIG. 14 is a cross-sectional view corresponding to FIG. 12, with the key having completed the unlocking sequence and the main lock components being unlocked and ready to be separated.

FIG. 15 is a cross-sectional view corresponding to FIG. 12, with the main lock components being partially disengaged and moving toward the fully separated position of FIG. 7.

### DETAILED DESCRIPTION OF EXAMPLE EMBODIMENTS

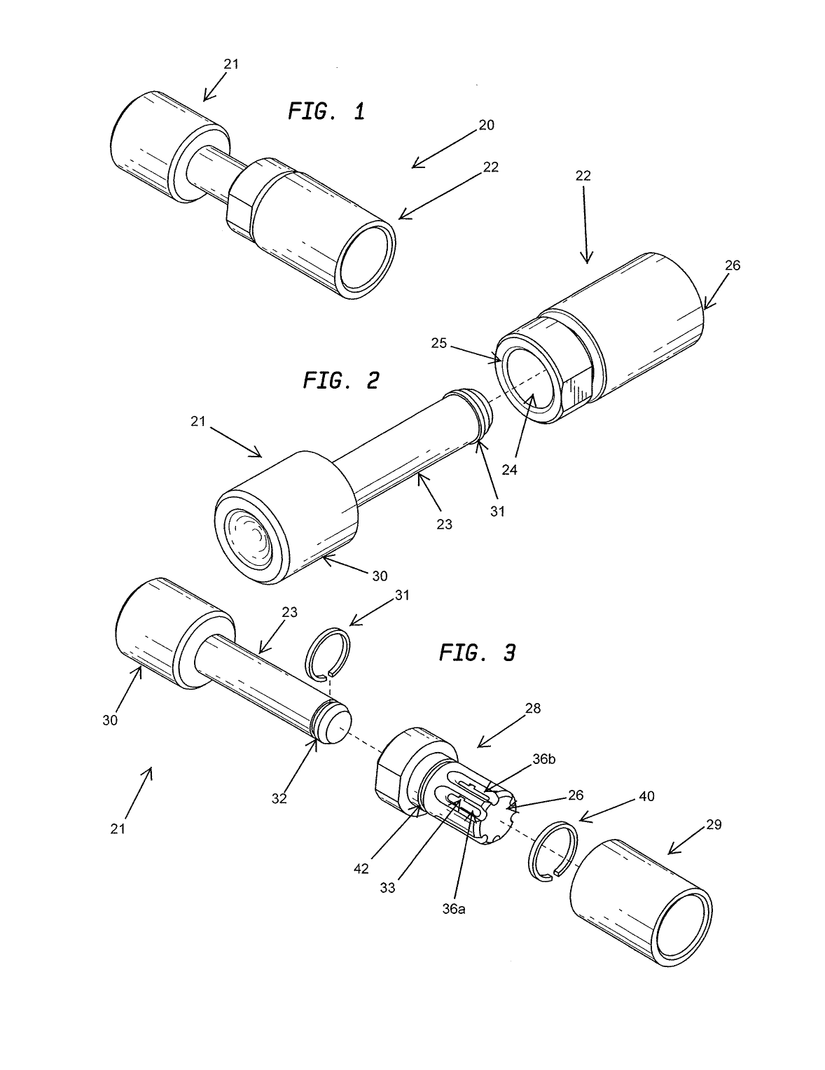

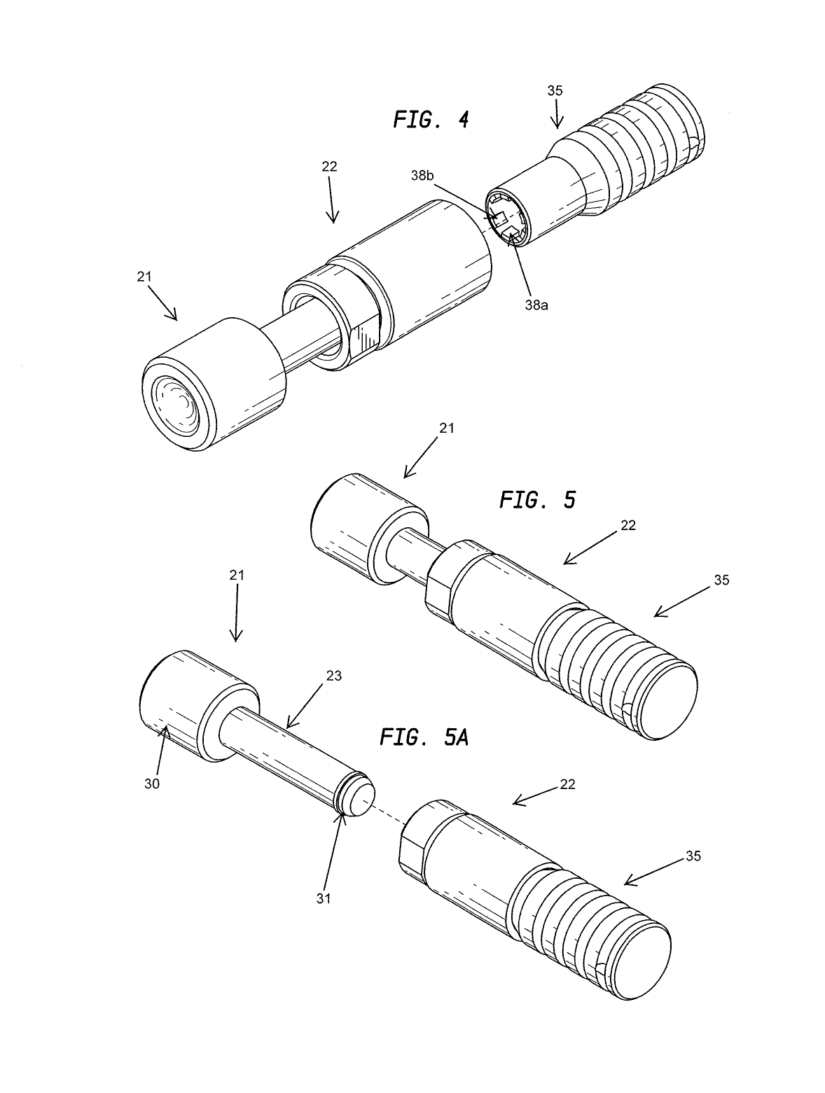

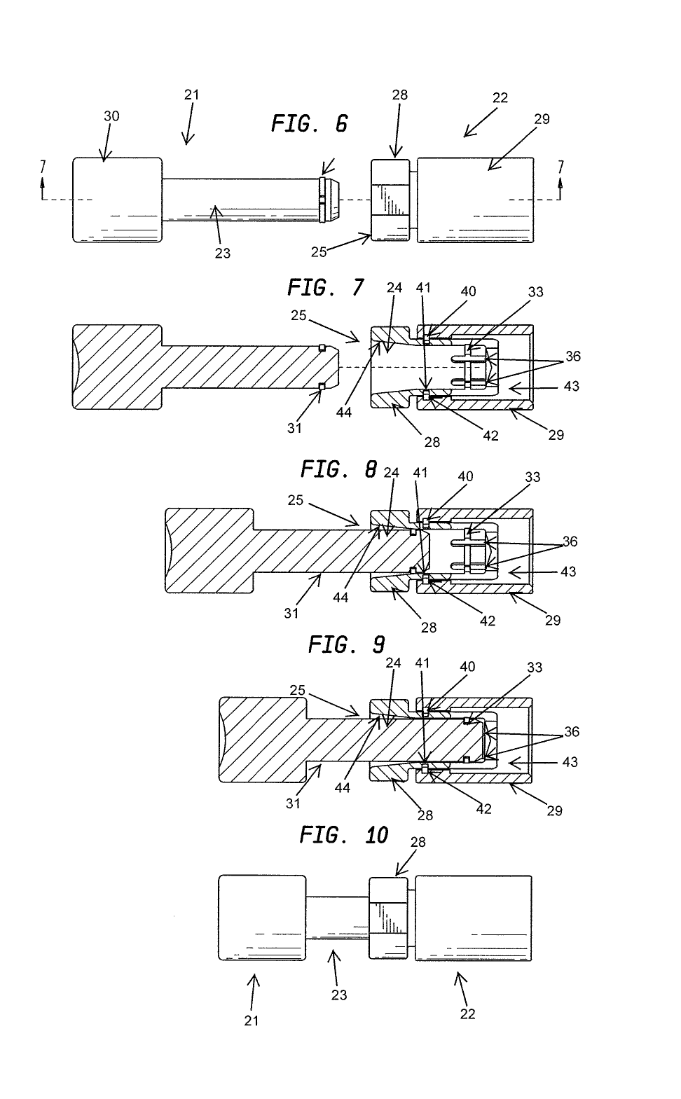

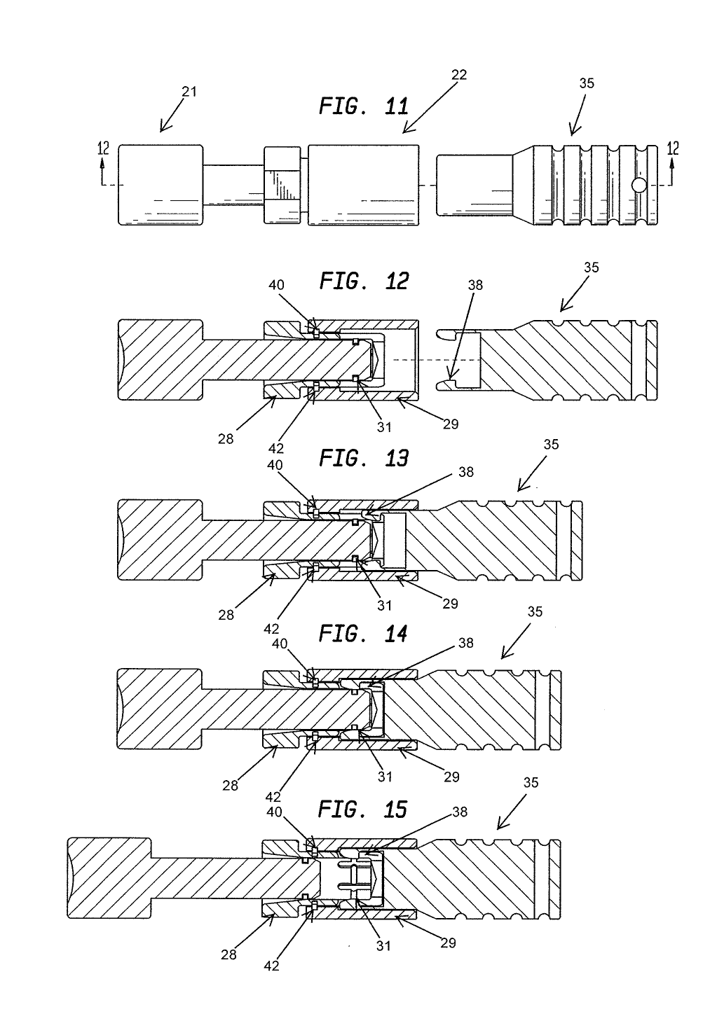

Turning now to the drawing figures, FIGS. 1-3 illustrate an example security lock that may be constructed in accordance with the present disclosure. The illustrated security lock 20 includes two main components, which may be configured in any desired manner for potentially any locking application. Examples include, but are not limited to, barrel locks, padlocks, cable locks, band clamp locks, and numerous other apparatus where locking functionality is needed. FIG. 1 shows the security lock in a locked position, with the main components 21 and 22 being joined together in locking engagement with each other. FIG. 2 shows the security lock in an unlocked and separated position, with the main components 21 and 22 being disengaged and displaced from each other. FIG. 3 shows the security lock in a disassembled state to illustrate the main components 21 and 22 together with various subcomponents thereof.

In FIGS. 1-3, a first one of the main lock components 21, shown on the left of each figure, is slidably insertable within a second one of the main lock components 22, shown on the right of each figure, and lockingly engagable therewith. In this embodiment, the first lock component 21 is shown for purposes of example only as being configured with a substantially cylindrical lock pin 23 (see FIGS. 2-3). The second lock component 22 is likewise shown for purposes of example only as being configured with a lock body having a substantially circular lock bore 24 (see FIG. 3). The lock bore 24 has a first pin-receiving end 25 that is open to receive the lock pin, and a second base end 26 that is shown as being closed. The base end 26 of the lock bore 24 could also be open if desired, but this may decrease security by providing the ability to engage the lock pin with an unauthorized tool in order to force it out of engagement with the lock bore. As further shown in FIG. 3, the lock bore 24 may be formed in a pin-receiving member 28 of the lock body, and the lock body may further include an outer protective shroud member 29 that mounts on the pin-receiving member 28. In an alternative embodiment (not shown), the shroud could be integrally formed on the pin-receiving member.

Depending on the locking application for which the security lock is designed, the lock pin 23 of the illustrated embodiment may be optionally configured with a base flange 30 that is enlarged relative to the remainder of the lock pin 23. If so provided, the base flange may be of any desired shape and size. By way of example only, and without limitation, the lock pin's base flange 30 is shown in FIGS. 1-3 as being generally cylindrical. The pin-receiving member 28 may likewise be optionally configured with an enlarged base flange 27 whose size and shape may correspond to that of the lock pin's base flange 30, or could be completely different, depending on design objectives.

As can be seen in FIG. 1, the foregoing configuration lends itself to applications in which the security lock is embodied as a stand-alone barrel lock, with no other connecting structure. Alternatively, if the illustrated lock components were attached to the ends of a cable (not shown), a cable lock could be provided. Likewise, if the components were attached to the ends of a band (not shown), a band clamp lock could be provided. It will be appreciated that other structures of various shape and size could be added to the lock pin and the pin-receiving member to produce still other lock types.

Locking engagement between the first and second lock components is provided by way of a deformable latch member on the first lock component engaging a latch retainer within the second lock component. In the illustrated embodiment, the deformable latch member comprises a compressible snap-ring 31 captured in a snap-ring mounting groove 32 on the lock pin 23, proximate to the free end of thereof (see FIGS. 2 and 3). The snap ring 31 is shown in FIG. 3 as having square cross-section. Other cross-sectional shapes could also be used, including rounded, rectangular, round, pointed, slanted, etc. The latch retainer in the illustrated embodiment comprises a corresponding snap-ring retainer groove 33 formed as an annular recess in the wall of the lock bore 24, somewhat proximate to the base end 26 thereof. As described in more detail below, the snap-ring retainer groove 33 is sized and configured to receive and lockingly engage the snap-ring 31 when the lock pin 23 is inserted in the lock bore 24. The groove may be of any shape that accommodates the snap ring, including rounded, square, rectangular, pointed, slanted, etc.

Snap-ring retention is provided by one side of the snap-ring retainer groove 33 (i.e., the side nearest the lock bore's pin-receiving end 25) acting as an annular retaining shoulder that engages the snap ring 31 to prevent the lock pin 23 from being withdrawn from the lock bore 24. The opposing side of the snap-ring-retainer groove 33 acts as a secondary retaining shoulder to engage the snap ring 31 and limit the lock pin's movement in the insertion direction. In an alternative embodiment (not shown), the annular retaining shoulder that prevents lock pin removal could be formed as a single step within the lock bore, in lieu of forming a groove. In that case, alternative structure could be used to limit lock pin movement in the insertion direction.

As additionally shown in FIG. 3, the second lock component 22 has a key-receiving configuration that slidably accepts a key, such as the key 35 shown in FIGS. 4, 5, and 5A, and allows it to contact the latch member. FIG. 4 illustrates the security lock in a locked position prior to engagement with the key 35. FIG. 5 illustrates the security lock following unlocking by the key 35, but prior to separation of the lock components 21 and 22. FIG. 5A illustrates the security lock following unlocking by the key 35 and separation of the lock components 21 and 22. As described in more detail below, the aforementioned unlocking is achieved by virtue of the key being configured to deform the latch member out of engagement with the latch retainer in order to release the first lock component 21 for slidable removal from the second lock component.

The key-receiving configuration of the second lock component may include at least one opening to accommodate at least one protrusion on the key that contacts the latch member when the key is placed in engagement with the second lock component. In the illustrated embodiment of FIG. 3, wherein the latch member is configured as a snap ring 31, the at least one opening of the key-receiving configuration comprises several openings formed as longitudinal grooves or slots 36a and 36b. As shown in FIG. 4, the at least one key protrusion comprises plural protrusions configured as longitudinal teeth 38a and 38b that are slidably engagable with the grooves 36a and 36b. The several openings 36 and key protrusions 38 are arranged in the illustrated embodiment to allow the key 35 to engage and deform the snap-ring 31 at different locations around its circumference.

As a practical matter, the use of only a single opening and key protrusion may be best suited for security lock embodiments that use some other type of latch member. One such alternative latch member that could be used in a security lock as disclosed herein would be small retractable latch pin carried on the lock pin. The latch pin could be biased radially outwardly from the side of the lock pin for engagement with a groove in the lock bore that serves as the latch retainer.

When the latch retainer is implemented as a snap ring latch retainer, as in the illustrated embodiment, it preferable to use a minimum of two openings and two key protrusions. In this minimal case, the openings and protrusions should be relatively wide (e.g., 25% of the ring reach) in order to ensure proper ring deformation. As the number of openings and key protrusions increases, their width may be correspondingly decreased. The number of openings and key protrusions is thus variable, and may be selected according to design preferences. Increasing the number of openings and key protrusions makes the lock very difficult to pick due to the multiple snap ring points required to be compressed simultaneously. For enhanced security, the openings may have irregular spacing relative to each other and the key protrusions may have a matching irregular spacing.

As shown in FIG. 3, the longitudinal grooves or slots 36 of the illustrated embodiment are configured to extend all the way through the wall of the pin-receiving member 28 so as to communicate with the interior pin-receiving lock bore 24 in the vicinity of the snap-ring retainer groove 33. The key 35 comprises a generally tubular structure with an interior sidewall whose nominal diameter is slightly larger than the outside diameter of the pin-receiving member 28, such that the key is slidably mountable thereon. The key's longitudinal teeth 38 extend radially inwardly from the key's interior sidewall, and are accommodated by the grooves or slots 36 in the key-receiving member 28. When the key 35 is placed in engagement with the pin-receiving member 28 and advanced thereon, the teeth 38 slide along the grooves or slots 36 until they contact and deform the latch member 31.

The shroud portion 29 of the lock body 22 may be thought of as adding a security feature to the above-described key-receiving configuration. In the illustrated embodiment, the shroud 29 is a tubular component that mounts on the lock body's pin-receiving member 28 by way of a shroud retaining ring 40. The shroud retaining ring 40 is disposed in opposing retainer grooves 41 and 42 respectively formed on an inside wall of the shroud 29 and an outside surface of the pin-receiving member 28. FIG. 3 shows the retainer groove 42 on the pin-receiving member 28. FIGS. 7-9, described in more detail below, illustrate the retainer groove 41 on the shroud 29. As mentioned above, the shroud could be integrally formed on the pin-receiving member in an alternative embodiment (not shown). The shroud 29 advantageously provides a circular key-way 43 for guiding the key 35 into engagement with the second lock component 22, with the teeth 38 of the key 35 slidably mating with the longitudinal grooves 36 on the pin-receiving member 28. The key-way 43 is restricted in size to prevent deformation of the latch member except by an authorized key. Without the shroud 29, it might be possible to deform the latch member without using the key 35, such as by using a conventional tool. That said, a security key as disclosed herein could be constructed without using a shroud, and would still be fully operational.

FIGS. 6-10 illustrate an example sequence of operations that may be performed to place the security lock 20 in a locked position. In these figures, the first and second lock components are embodied, for purposes of example only, in the manner shown in FIGS. 1-5. As noted above, this example embodiment includes the first lock component 21 being configured with a lock pin 23 having a snap-ring 31 that provides a deformable latch member. This example embodiment further includes the second lock component 22 being configured with a lock body 28 having a lock bore 24 and a snap-ring retainer groove 33 providing a latch retainer.

FIGS. 6 and 7 show the first and second lock components 21 and 22 separated from each other in an unlocked position. In this position, the lock pin 23 of the first lock component 21 has not yet entered the lock bore 24 of the second lock component 22. As can be seen in FIG. 7, the sidewall of the lock bore 24, which extends at least between the snap-ring retainer groove 33 and the lock bore's open end 25, is adapted to receive the lock pin 23. If desired, the lock bore sidewall may be formed with a frustoconical cam surface 44 that tapers radially inwardly from the open end 25 of the bore 24 until it reaches a main portion of the bore having a constant nominal diameter. The cam surface 44 serves to both guide the end of the lock pin 23 (which may be tapered) for entry into the main (constant diameter) portion of the lock bore 24, and to gradually deform the snap-ring 31 to facilitate such entry.

FIG. 8 shows the lock pin 23 of the first lock component 21 after it has entered the lock bore 24 of the second lock component 22. In this position, the tip of the first lock component's lock pin 23 has passed the end of the cam surface 44 on the second lock component's lock bore 24 sidewall. The cam surface 44 has deformed the snap-ring 31 to a fully compressed state as it starts its entry into the nominal constant-diameter portion of the lock bore 24.

In FIGS. 9 and 10, the first and second lock components 21 and 22 are fully engaged in the locked position. In this position, the first lock component's lock pin 23 has been fully inserted into the lock bore 24 of the second lock component's pin-receiving member 28. The lock pin's snap ring 31 is seated in locking engagement with the lock bore's snap-ring retainer groove 33. Insofar as the snap-ring-retainer groove 33 is larger in diameter than the nominal diameter of the lock bore 24, the snap-ring 31 is allowed to decompress and expand to its nominal diameter (which is larger than the lock bore nominal diameter), thereby becoming captured in the retainer groove 33.

FIGS. 11-15 illustrate an example sequence of operations that may be performed to unlatch the security lock 20 and place it in an unlocked position. In these figures, the first and second lock components are again embodied, for purposes of example only, in the manner shown in FIGS. 1-5. As noted above, this example embodiment includes the first lock component 21 being configured with a lock pin 23 having a snap-ring 31 that provides a deformable latch member. This example embodiment further includes the second lock component 22 being configured with a lock body having a lock bore 24 and a snap-ring retainer groove 33 providing a latch retainer. This embodiment further includes the key-receiving configuration on the second lock component 22 being formed with plural longitudinal grooves 36 on the pin-receiving member 28. The key 35 is likewise formed with plural longitudinal teeth 38 that are slidably engagable with the grooves 36 in order to contact and deform the snap-ring 31 that provides the latch member.

In FIGS. 11 and 12 the first and second lock components 21 and 22 are fully engaged in the locked position. In this position, the first lock component's lock pin 23 is fully inserted in the lock bore 24 of the second lock component's pin-receiving member 28. The lock pin's snap ring 31 is seated in locking engagement with the lock bore's snap-ring retainer groove 33.

FIG. 13 shows the key 35 after it has been partially inserted into engagement with the second lock component 22. In this position, the key 35 is disposed within the shroud 29 of the second lock component 22, with the key's longitudinal teeth 38 starting to slidably mate with the pin-receiving member's longitudinal grooves 36.

FIG. 14 shows the key 35 after it has been fully inserted into the second lock component 22. In this position, the key 35 has deformed the first lock component's latch member by virtue of its longitudinal teeth 38 fully engaging and compressing the lock pin snap-ring 31. As can be seen, the forward end of the longitudinal teeth 38 are beveled to facilitate the snap-ring 31 compression action.

FIG. 15 shows the first lock component 21 being withdrawn from the second lock component 22. In this position, the lock pin 23 of the first lock component 21 is slidably moving to the left within the lock bore 24 of the second lock component's pin-receiving member 28. The lock pin's snap ring 31 is entering the region of the lock bore's tapered cam surface 44. Further withdrawal of the lock pin 23 will release the snap ring 31 from its compressed state, returning to its nominal uncompressed state as the first and second lock components 21 and 22 are separated.

Accordingly, a security lock has been disclosed. While various embodiments have been shown and described, it should be apparent that many variations and alternative embodiments could be implemented in accordance with the present disclosure.

For example, in one alternative embodiment (not shown), the security lock could be constructed with two or more deformable latch members (e.g., snap rings) and two or more corresponding latch retainers (e.g., snap ring grooves). This would increase the number of moving parts but may provide increased security for applications that require it.

According to another alternative embodiment (not shown), a “shroudless” version of the security lock could be constructed in which the base end of the pin-receiving member's bore is open. Its longitudinal slots would extend radially outwardly from the lock bore, beyond the bottom of the snap ring retainer groove, but not entirely through the sidewall. The outside of the pin-receiving member's would thus be solid, and no surrounding shroud would be used. The key would be inserted into the open base end of the lock bore and would have longitudinal prongs that slide along the slots. The key's longitudinal prongs could have tapered ends that engage the outside diameter of the snap ring and compress it out of engagement with the snap ring retainer groove.

According to another alternative embodiment (not shown), an “inside-out” version of the security lock could be constructed in which the locations of the snap ring and the snap ring retainer groove are reversed. In other words, the snap ring would be mounted inside the lock bore of the pin-receiving member, and the snap ring retainer groove would be formed on the lock pin. The lock pin could have longitudinal key-receiving slots that extend radially inwardly beyond the bottom of the snap ring retainer groove. The pin-receiving member could have a solid sidewall with an open, key-receiving base end providing access to the lock pin bore. The end of the key could have longitudinal prongs that enter the lock pin bore through the pin-receiving member's open base end. The key's longitudinal prongs would slidably engage lock-pin's key-receiving slots. As the key is advanced, tapered ends on the longitudinal prongs would contact the inside diameter of the snap ring mounted in the pin-receiving bore and bias it outwardly, out of engagement with the lock pin.

In the above-described “inside out” version of the security lock, it will be appreciated that the deformable latch member, as represented by the snap ring, will be on the second lock component rather than the first lock component (as shown in the illustrated embodiments previously discussed). Likewise, the latch retainer, as represented by the snap ring retainer groove, will be on the first lock component rather than the second lock component (as also shown in the illustrated embodiments previously discussed). It will therefore be appreciated that, in any security lock constructed in accordance with the present disclosure, the deformable latch member may be on either one of the lock components, and the latch retainer may be on the other lock component.

It is understood, therefore, that the invention is not to be in any way limited except in accordance with the scope of the appended claims.

What is claimed is:

1. A security lock, comprising:
a first lock component lockingly engagable within a second lock component by way of a deformable latch member on one of said lock components engaging a latch retainer on the other of said lock components, and a key-receiving configuration on said lock component having said latch retainer that accepts a key, said key being configured to deform said latch member in order to release said first lock component from said second lock component and thereby unlock said security lock, said security lock being lockable without said key.

2. The security lock of claim 1, wherein said first lock component comprises a lock pin.

3. The security lock of claim 2, wherein said second lock component comprises a lock body having a lock bore configured to receive said lock pin.

4. The security lock of claim 1, wherein said deformable latch member comprises a single moving part.

5. The security lock of claim 1, wherein said deformable latch member comprises a compressible snap-ring.

6. The security lock of claim 5, wherein said latch retainer comprises a retainer groove configured to receive and lockingly engage said snap-ring.

7. The security lock of claim 1, further including a cam surface that deforms said latch member prior to said latch member engaging said latch retainer.

8. The security lock of claim 1, wherein said key-receiving configuration comprises at least one opening to accommodate at least one protrusion on the key that contacts the latch member.

9. The security lock of claim 8, wherein said at least one opening of said key-receiving configuration comprises plural openings configured as longitudinal grooves and said at least one key protrusion comprises plural protrusions configured as longitudinal teeth that are slidably engagable with said grooves.

10. The security lock of claim 9, wherein said grooves have irregular spacing relative to each other and said teeth have a matching irregular spacing to provide a security function.

11. The security lock of claim 9, wherein said key-receiving configuration includes a shroud providing a key-way for guiding said key, said key-way being restricted in size to prevent deformation of said latch member except by said key.

12. A security lock mechanism, comprising:
a lock pin;
a lock body;
a lock bore in said lock body configured to receive said lock pin;
a compressible snap-ring on said lock pin;
a retainer groove in said lock bore;
a sidewall on said lock bore between said retainer groove and an open end of said lock bore adapted to receive said lock pin, a portion of said sidewall defining a tapered cam surface to compress said snap-ring as said lock pin advances in said lock bore;
said retainer groove being sized to allow said snap-ring to uncompress and thereby become captured in said retainer groove in locking engagement therewith, said locking engagement securing said lock pin in said lock bore;
said lock body having one or more openings permitting access to said snap-ring by one or more protrusions on a key that is configured to engage said lock body with said key protrusions compressing said snap-ring out of said locking engagement with said retainer groove, thereby releasing said lock pin from said lock bore; and
a shroud on said lock body, said shroud providing a key-way for guiding said key during its engagement with said lock body, said key-way being restricted in size to prevent deformation of said snap ring except by said key.
